(19) United States
(12) Patent Application Publication
(10) Pub. No.: US 2005/0190344 A1
(43) Pub. Date: Sep. 1, 2005

(54) Projection apparatus

(75) Inventor: Tzung-I Lin, Miao-Li County (TW)

Correspondence Address: Min, Hsieh & Hack, LLP;c/o PortfolioIP, P.O. Box 52050, Minneapolis, MN, 55402, US

(73) Assignee: Coretronic Corporation

(21) Appl. No.: 11/059,460

(22) Filed: Feb. 16, 2005

(30) Foreign Application Priority Data
Feb. 27, 2004 (TW) 093202999

(51) Int. Cl. G03B 21/22; G03B 21/00

(52) U.S. Cl. 353/71

(57) ABSTRACT

A projection apparatus includes a base, a main body and a reflective mirror. The base is equipped with a DVD player therein, and the main body is supported on the base and has a projection lens for projecting an image light beam. The reflective mirror is disposed outside the base and has a reflecting surface facing the projection lens. After the projection apparatus is hung on the wall, the image light beam projected from the projection lens goes through the planar or the curved reflective surface in front of the projection lens for a reflective effect. The light beam is bent, zoomed or corrected its distortion, and then the corrected image picture is displayed on the screen for saving the projector configuration space, increasing the zooming amplification, correcting the image distortion, as well as simplifying the wiring configuration.

### FIELD OF THE INVENTION

The present invention relates to a projection apparatus, and more particularly to a projection apparatus capable of increasing the projection distance, integrating DVD playing and simplifying wiring.

### BACKGROUND OF THE INVENTION

Projectors are usually disposed on the desktop or installed on the ceiling, and through the connection with the playing equipment (for example: The video and music playing equipment (DVD player), the image playing equipment (VCD player)), in order to transmit image signals to projectors. Then projectors are used to show the image and pictures on the projection screen. However, the playing equipments are generally disposed near the monitor, and the connection cable between the projector and the playing equipment needs to be extended, causing the difficulty to dispose and fasten the cable connection, and the cable is exposed on the ground and then causes the inconvenience while a person walking by. Moreover, it needs certain projection distance when the projector displays image in order to show the proper size of image, but there is usually not enough space that the projectors cannot be setup in a proper position. This causes the insufficient projection distance and the projector is unable to enlarge the image display proportion.

Therefore, now we still have problems that projectors have insufficient space, causing the insufficient projection distance and the difficulty of the configuration of connection cables, and these problems are to be solved by researchers.

### SUMMARY OF THE INVENTION

One object of the present invention is to provide a projection apparatus that takes advantage of the design of the projector with a reflective mirror disposed on the base. Then it is possible to dispose the main body of the projector on the wall in order to increase the projection distance and save the projector allocation space in a limited space.

Another object of the present invention is to provide a projection apparatus that takes advantage of disposing the DVD playing equipment into base in order to simplify the system structure and solve the wiring problems.

Still another object of the present invention is to provide a projection apparatus that takes advantage of disposing a main body of the projector on the adjustable base in order to be adjusted to a correct and not deformed projection conveniently and quickly.

Still another object of the present invention is to provide a projection apparatus that takes advantage of disposing a reflective mirror with a curved surface in order to achieve the object of correcting image distortion.

Still another object of the present invention is to provide a projection apparatus that the consumers may select according to his demand to have the following variation: without the reflective mirror it is used as a desktop projection apparatus, and with the reflective mirror it is hang on the wall to be a multi-purpose projection apparatus.

In order to achieve the above objects, the projection apparatus of the present invention includes a base, a main body of the projector and a reflective mirror. A playing equipment is disposed inside the base, the main body of the projector is carried on the base and equipped with a projection lens that can provide an image beam, and the reflective mirror is disposed outside the base and equipped with a reflective surface that faces the projection lens. After the projection apparatus is hung on the wall, the image light beam projected from the projection lens penetrates its front plane or curved reflective surface and have a reflective effect, then the light beam is bended, zoomed or corrected the distortion thereof in order to display the corrected image picture on the screen, so as to achieve the objects of saving the projector configuration space, enlarging the amplification, correcting the image distortion, and simplifying the configuration of connection cables.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is the perspective view of the projection apparatus in the present invention.

FIG. 2A is the lateral view of the projection apparatus with the planar reflective mirror in the present invention.

FIG. 2B is the lateral view of the projection apparatus with the curved reflective mirror in the present invention.

FIG. 3 is the lateral view of the second embodiment of the projection apparatus in the present invention.

FIG. 4 is the lateral view of the third embodiment of the projection apparatus in the present invention.

FIG. 5 is the lateral view of the fourth embodiment of the projection apparatus in the present invention.

### DETAILED DESCRIPTION

To make it easier to understand the objects of the invention, we use preferred embodiments together with the attached drawings for the detailed description of the invention.

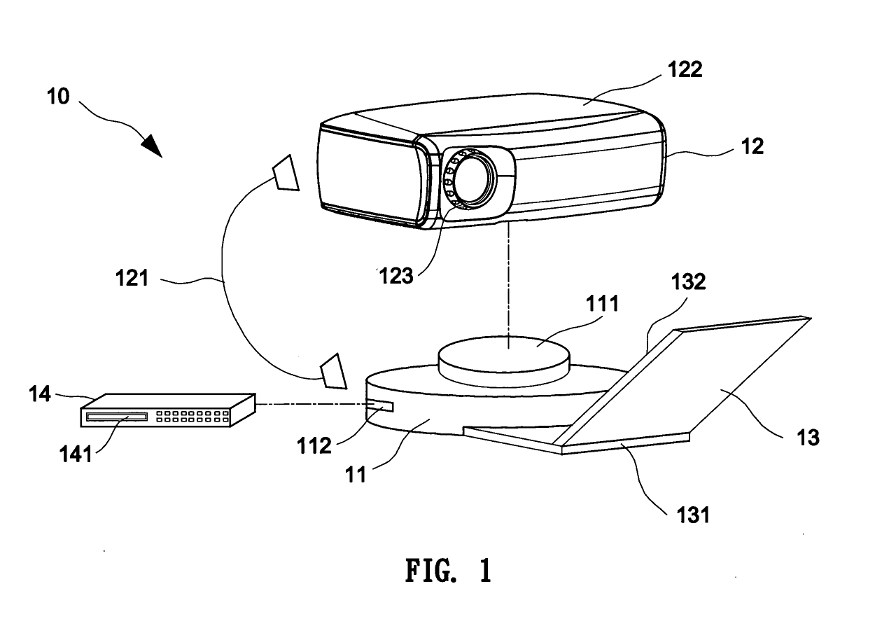

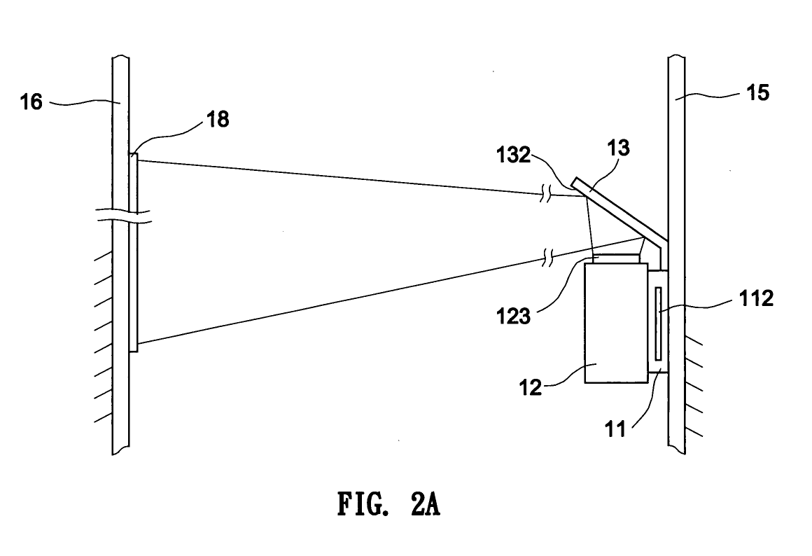

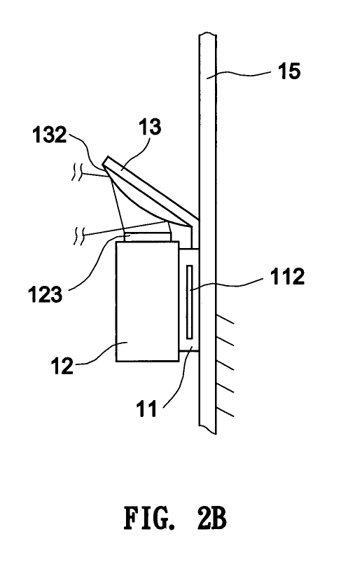

Please refer to FIG. 1. The projection apparatus 10 on the wall includes a base 11, a main body 12 and a reflective mirror 13. The base 11 is equipped with a bearing surface 111 on the upper side, an open mouth 112 on the lateral side, and a playing equipment 14 inside the base 11. The playing equipment 14 can be a DVD or a VCD playing equipment, and the playing equipment 14 is equipped with a suction mouth 141 facing the open mouth 112 in order to let various kinds of disks can be put into the playing equipment 14 through the open mouth 112 of the base 11. The main body 12 is disposed on the bearing surface 111 of the base 11 and connected with the playing equipment 14 through a connection cable 121. The main body 12 includes a case 122, the optical components (not shown in the figure) disposed in the case 122, the electrical components (not shown in the figure) and a projection lens 123. The optical and electrical components deal with the light beam and the imaging signal in order to produce the image light beam, and then project the image light beam through the projection lens 123 to the exterior of the main body 12. The reflective mirror 13 is disposed on one side of the base 11 and the bottom 131 is fixed on the base. Inner surface of the reflective mirror 13 is a reflective surface 132, and the reflective surface 132 is disposed facing the projection lens 123. The reflective surface 132 can be planar (as shown in FIG. 2A), curved surface (as shown in FIG. 2B) and so on. The curved surface cab be set to a different curvature radius according to the image projected from the projection lens 123, for example: when there is trapezoid distortion whose upper side is longer and lower side is shorter than the original projection image, we can set the curvature radius of the curved surface to be larger on upper side and smaller on lower side. When the image is reflected by the curved surface, the magnification of the upper side of image is smaller than the lower side of image, for correcting the projection image distortion. When magnification of the image projected to the screen 18 is insufficient, we can modify the curvature radius of the curved surface in order to magnify the projection images.

Please refer to FIG. 2A. The projection apparatus 10 is locked on the first wall 15 by the locking base 11 in order to be a hanging projector. When the image light beam projected from the projection lens 123 on the front end reflective mirror 13, the image light beam 132 will have a reflection effect on the refection surface 132, the light beam is bent or zoomed and then projected on the second wall 16 disposed opposite to the first wall 15. Thus the image will be shown on the second wall 16 in order to be viewed by users. Since the main body of the projector can be hanging on the wall, the projector configuration space can be saved. Through the setup of the reflective mirror 13, the image light beam emitted from the projection lens 123 is bent and then the distance between the projection lens 123 to the screen 18 is extended for magnifying the image proportion on the screen 18. Then, it is possible to increase the projection distance and the image magnification proportion in a limited space.

Moreover, by adding the base 11 internally equipped with the playing equipment 14, and loading the main body 12 directly on the base 11, the distance between the main body 12 and the playing equipment 14 can be shortened. Thus, shorter wiring cable 121 can be used to connect the main body 12 and the playing equipment 14. This simplifies the wiring configuration and fixing, and it may also prevent the wiring from exposure to the ground and hindering people from walking by.

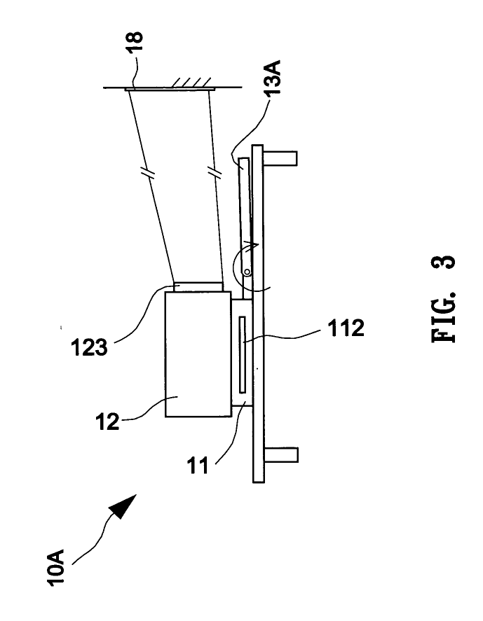

Further, please refer to FIG. 3. The components in this embodiment equal or equivalent to the first embodiment uses the same reference numbers, and the difference between this embodiment and the above embodiment is: projection apparatus 10A of the present invention can be disposed directly on the table, wherein one end of the reflective mirror 13A is pivoted at the bottom of the base 11, and when the reflective mirror 13A rotates around the pivot to the position that the reflective mirror 13A does not block the projection lens 123, the image light beam projected from the projection lens 123 projects directly on the screen 18. Therefore, the projection apparatus of the present invention can vary according to users' requirement, without the reflective mirror it is used as a desktop projection apparatus, or with the reflective mirror it is hung on the wall in order to be a multi-purpose projection apparatus.

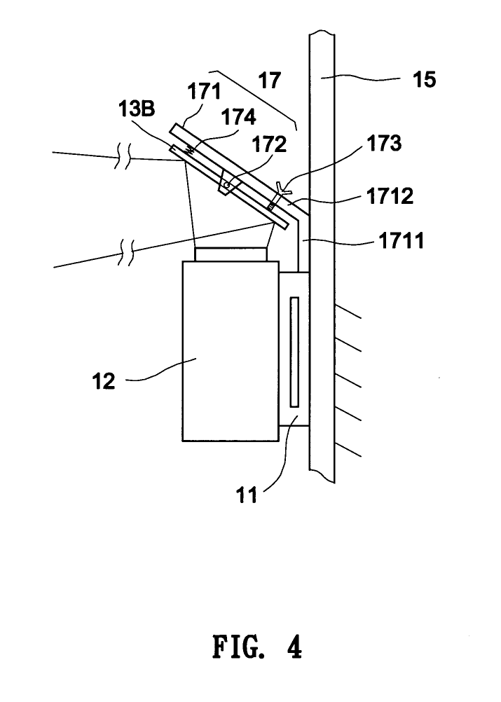

Please refer to FIG. 4, the components in the present embodiment equal or equivalent to the first embodiment uses the same reference numbers, and the difference between this embodiment and the above embodiment is: there is an adjusting mechanism 17 on the back of the reflective mirror 13B, and the adjusting mechanism 17 includes a supporting seat 171, a pivot 172, an adjusting component 173 and a recuperating component 174. The supporting seat 171 includes a bottom board 1711 and an inclined board 1712. The bottom board 1711 is connected with the base 11 at one end and connected with the inclined board 1712 at the other end. The reflective mirror 13B is disposed on the inclined board 1712 and the center thereof is pivoted to the inclined board 1712 by the pivot 172. The adjusting component 173 is screwed on one end of the inclined board 1712 with the top side thereof against one end of the back of the reflective mirror, and the recuperating component 174 is fixed on the other end of the inclined board 1712 with the top side against one end of the back of the reflective mirror 13B. The recuperating component 174 can be an elastic part.

By rotation of the adjusting component 173 and the function of the recuperating component 174, the reflective mirror is against by the adjusting component 173 or the recuperating component 174 and then rotates around the pivot 172, and afterward the inclination angle of the reflective mirror 13B is adjusted. When the image projected by the projection lens 123 is deformed, it is also possible to correct the image by using the adjusting mechanism 17 to properly adjust the angle of the reflective mirror.

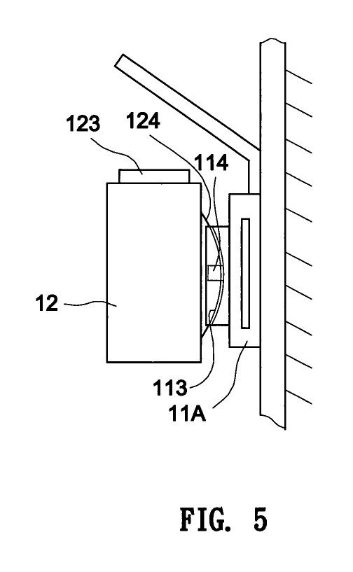

Please refer to FIG. 5, the components in the present embodiment equal or equivalent to the first embodiment use the same reference numbers, and the difference between this embodiment and the above embodiment is: the base 11A is an adjustable base, and there is an arc groove 113 disposed on the base 11A. There is an arc surface 124 disposed below the main body 12 in order to match with the arc groove 113. The arc surface 124 is disposed inside the arc groove 113, and there is a universal joint 114 disposed between them in order to connect the arc groove 113 and the arc surface 124. When the main body 12 is moved, the universal joint 114 is driven to rotate in order to adjust the multi-axial angle of the main body 12 for adjusting the image to a correct and non-distorted projection.

Although the invention has been described in detail herein with reference to its preferred embodiments, it is to be understood that this description is by way of example only, and is not to be interpreted in a limiting sense. It is to be further understood that numerous changes in the details of the embodiments of the invention, and additional embodiments of the invention, will be apparent, and may be made by, persons of ordinary skill in the art having reference to this description. It is considered that such changes and additional embodiments are within the spirit and true scope of the invention as claimed below.

1. A projection apparatus, including:
a base,
a main body being carried on the base and having a projection lens for providing an image light beam, and
a reflective mirror disposed outside the base and having a reflective surface on the inner surface thereof, the reflective surface being disposed facing the projection lens for reflecting the image light beam.

2. The projection apparatus according to claim 1, wherein a playing equipment is disposed inside the base.

3. The projection apparatus according to claim 1, wherein the reflective surface is planar.

4. The projection apparatus according to claim 1, wherein the reflective surface is curved.

5. The projection apparatus according to claim 1, wherein the base is hung on a wall.

6. The projection apparatus according to claim 1, wherein an adjusting mechanism is disposed on the back of the reflective mirror.

7. The projection apparatus according to claim 1, wherein one end of the reflective mirror is pivoted to the base.

8. The projection apparatus according to claim 1, wherein the base is an adjustable base for adjusting the projection angle of the main body.

9. The projection apparatus according to claim 8, wherein the adjustable base includes a universal joint.
